(19) United States
(12) Patent Application Publication
(10) Pub. No.: US 2025/0277901 A1
(43) Pub. Date: Sep. 4, 2025

(54) COMBINING SENSOR OUTPUTS TO IMPROVE STRUCTURE DETECTION IN LIMITED VISIBILITY ENVIRONMENTS

(71) Applicant: Summer Robotics, Inc., Campbell, CA (US)

(72) Inventors: Gerard Dirk Smits, Los Gatos, CA (US); Steven Dean Gottke, Concord, CA (US)

(21) Appl. No.: 19/035,554

(22) Filed: Jan. 23, 2025

Related U.S. Application Data
(60) Provisional application No. 63/624,687, filed on Jan. 24, 2024.

(51) Int. Cl. G01S 13/86; G01S 7/40; G01S 7/497; G01S 7/52; G01S 13/06; G01S 15/06; G01S 15/86; G01S 17/06

(52) U.S. Cl. CPC G01S 13/862; G01S 7/40; G01S 7/497; G01S 7/52004; G01S 13/06; G01S 13/865; G01S 13/867; G01S 15/06; G01S 15/86; G01S 17/06

(57) ABSTRACT

A system that combines different types of sensors to improve detection of structures that are difficult to perceive in three dimensional (3D) environments that are visually limited. The system employs data provided by different types of sensors to concurrently perform several methods, including sonar, radar, Time-Of-Flight and/or triangulation. The results of these methods are combined to detect structures in 3D environments that have different types of visually limiting effects. For example, atmospheric effects may include snow, rain, fog, dust, turbulent air, and/or atmospheric refraction; and underwater effects may include turbidity, thermal layers, density layers, and/or air bubbles. The different types of sensors may include one or more image sensors, event sensors, Time-Of-Flight sensors and cameras, radar sensors, sonar sensors, thermopile laser sensors, and the like.

### CROSS-REFERENCE TO RELATED APPLICATION

This application is a Utility Patent application based on previously filed U.S. Provisional Patent Application U.S. Ser. No. 63/624,687 filed on Jan. 24, 2024, the benefit of the filing date of which is hereby claimed under 35 U.S.C. § 119(e), and the contents of which is further incorporated in entirety by reference.

### TECHNICAL FIELD

The present innovations relate generally to machine sensing or machine vision systems, and more particularly, but not exclusively, to structure detection in limited visibility environments.

### BACKGROUND

State of the art computer systems rely on the computationally advanced signal processing of frames of images. In these conventional systems image frames are perused for “features” which are typically clusters of pixels that reveal “structure”, e.g. the edge of an object being imaged-that is rendered by a process of reversed projection, light intensity variances from pixel to pixel, searching for patterns of contrast between neighboring pixels that vary in grey scale (a measure of light intensity, i.e. photons received during a certain time period-the exposure time of a frame). Many real-world things get in the way for this essential first step in computer vision to reliably result in useful actional information. Motion blur, lack of focus, lack of photons (i.e., “photon starvation”) and often plainly an insufficiency of contrast available (e.g., fading signs, lack of color contrast, invisibility of 3d shapes due to excessive diffuse lighting such as lack of shadows in fog or excessively uneven lighting).

Though scanning laser-based triangulation systems address already most of the above challenges, but there may always be some situations where even the most highly engineered, most advanced active light systems still fail. 3-D perception in difficult environments continues to be a challenge. In particular, attenuation of electromagnetic beams is a significant problem that can be caused by absorption and/or scattering, which are both highly wavelength dependent. Multiple techniques may be used for 3-D perception (such as sonar, radar, Lidar, scanning triangulation) simultaneously to ameliorate these problems, but they cannot be eliminated completely. In the air, atmospheric effects such as fog, rain, snow, dust, turbulent air, or atmospheric refraction may be present individually or simultaneously. For instance, fog may be impenetrable to visible wavelength of light, but allow significant penetration by radar. Rain, snow or dust can limit light at all frequencies to some extent. Turbulent air may cause distant structures to shimmer. And variations in air density can cause atmospheric refraction that produces mirages. Underwater perception has similar issues, where water turbidity, thermal or density layer transitions, air bubbles and many other factors can severely limit both perception range and resolution. Sonar and radar can extend the maximum range of scanning, but cannot match the resolution available to light scanning techniques.

### BRIEF DESCRIPTION OF THE DRAWINGS

FIG. 1A is a process showing a method of combining information from multiple sensors according to specific embodiments of the invention.

FIG. 1B is a perspective view of a scanning system according to specific embodiments of the invention.

FIGS. 1C and 1D are close-up views of portions of the system as shown in FIG. 1B.

FIG. 2A is a top view showing portions of the scanning system under conditions of uncertainty according to specific embodiments of the invention.

FIG. 2B is a diagram showing a portion of an image sensor according to specific embodiments of the invention.

FIG. 3 is a process showing a method of combining information from multiple sensors according to specific embodiments of the invention.

### DETAILED DESCRIPTION OF THE INVENTION

Time of Flight methods (ToF) exploit the observed time of flight of a temporally structured signal, and by multiplying that observed time interval with the known speed of electromagnetic waves in a medium. Sonar, Lidar, and radar are three forms of ToF systems (using sound, light, and radio signals respectively), though not all of these are suitable for all mediums. Triangulation methods use observations from multiple perspectives, to determine parallax, the geometric shift of observed points which inversely correlates to their distance from the observers. Triangulation can be achieved with static, structured light projection, scanning beams, or other methods. ToF and triangulation methods can be applied simultaneously and synergistically in a laser scanning system. ToF systems are naturally good at achieving range estimations with accuracies of 15 cm or greater at distances farther afield (e.g., 15 m meters or more) thus achieving roughly a 1% range accuracy. But ToF systems are a poor choice for determining mm precise range features, simply because it takes electromagnetic waves just 3 picoseconds to traverse a mm in space and measuring time in picoseconds requires clocks running at a terahertz speeds. Measuring the arrival of single photon with picosecond precision is beyond the current state of the art. Triangulation systems in contrast, can achieve sub mm accuracy through basic geometric scaling in the near-field. On the other hand, triangulation often has fundamental far-field accuracy limitations, imposed by geometry; unless the base line of the system can be expanded (e.g. an array of receivers can physically or synthetically, by computational means, adjust the base line). Laser scanning systems that combine both triangulation and ToF methods thus can overcome known, real and fundamental limitations of either system, and a combined system can be truly synergistic in that way.

In some embodiments, a third sensing functionality can be added to improve overall performance. For example, when measuring underwater, one might achieve three-way sensing fusion synergy by combining sonar, ToF, and laser triangulation methods in turbid waters. Sonar is perhaps the oldest form for ToF; in the case of sonar using echolocation, sound waves are sent through a medium (in this case water) and the reflections of these acoustic waves are analyzed to estimate the distance these waves travelled back and forth between the transmitter, the reflecting surface, and the receiver. Sounds travel a lot faster in water than in air but nowhere as close to the speed of light. It might appear that achieving great accuracy should be simpler using sonar, but this is not necessarily true, because due to the laws of diffraction, it is quite difficult to make highly collimated “sound beams,” which are limited by the Raleigh Diffraction Criterion, which limits the resolution of any proportional to the wavelength of energy wave/divided by the size of the aperture of the receiver. Less directed sound waves can be used but are highly susceptible to scattering interference, as well as losing much resolution due to its longer effective wavelength. Recent developments in sonar have improved speed and resolution of scanning, but still cannot achieve accuracy anywhere close to resolution available on even an inexpensive camera, even though its range might be much higher than optical methods. For example, underwater when using 450 nm light to scan with a 1 cm aperture, the diffraction-limited resolution is ˜3.5×10-5 radians. Reasonably high resolution sonar at 240 kHz has an effective wavelength of 6.25 mm (assuming typical speed of sound under common conditions of 1500 m/s). With a 1 m receiver array, this gives an effective angular resolution available of 3.5×10-3 radians. Sonar also takes more time to scan a given portion of the scene given the slower speed of sound.

Attenuation comprising absorption and scattering remains a large challenge under water. Light scattering and absorption reduce a laser beam intensity by 2-10% per meter even in relatively clear water. Even with extremely powerful directed beams the practical range limits to underwater LIDAR is around 50 meters (100 meters round trip). In high turbidity conditions of coastal waters, when as much as half of the laser signal is scattered each meter, this range might be reduced to 5meters, because due to scattering alone just 1/1,000th (transmission=0.5\hat{ }10) of the photons directed towards a target can survive along the ray direction for the full round trip required of 10 meters. In addition, the normal 1/R2 law diminishes the returning light as it spreads across a Lambertian reflection cone. This attenuation creates dual challenges: an extremely weak return signal and a large amount of scattered noise. Note that challenge posed by signal scattering, particularly backscattering, tends to blind both LiDAR and high frequency sonar systems, as any scattering sources (air bubbles, phytoplankton, suspended particulates, etc.) in the near field of transmitter beam may act as a particularly bright noise source that may mask the already very faint reflected signals. Triangulation is still affected by scattering, but not as severely; scattering may occur along the path of the scanned beam but is less likely to trigger the detector as it is spread out along the projection of the beam. Nevertheless, absorption and scattering along a beam path can still heavily limit the range of all these methods with the additional exponential drop-off in signal as linear distance increases. In clear water, high resolution scanning could be accomplished using scanning triangulation alone, but under turbid or other visually difficult conditions, other scanning modalities can be combined with triangulation to filter out noise and allow data capture of a scene with high fidelity.

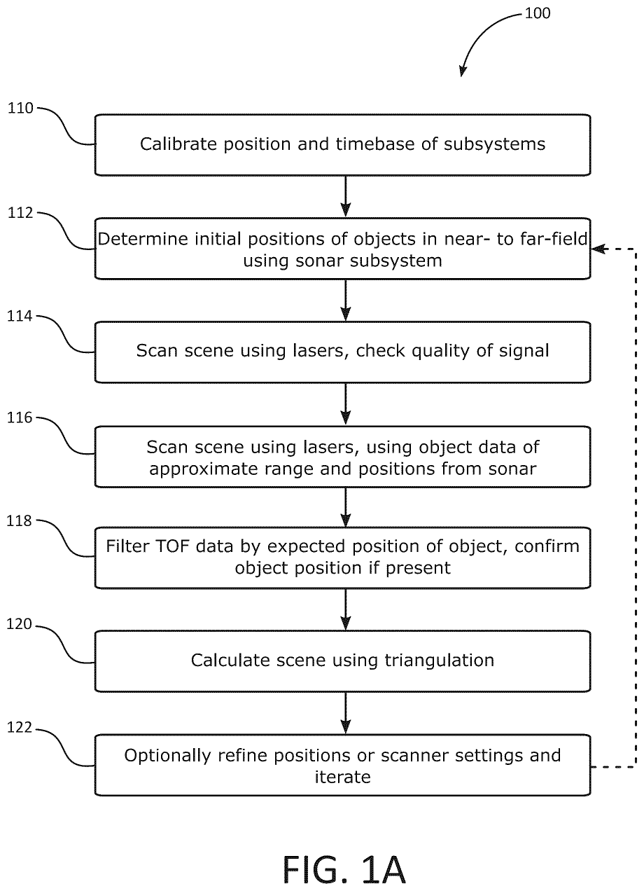

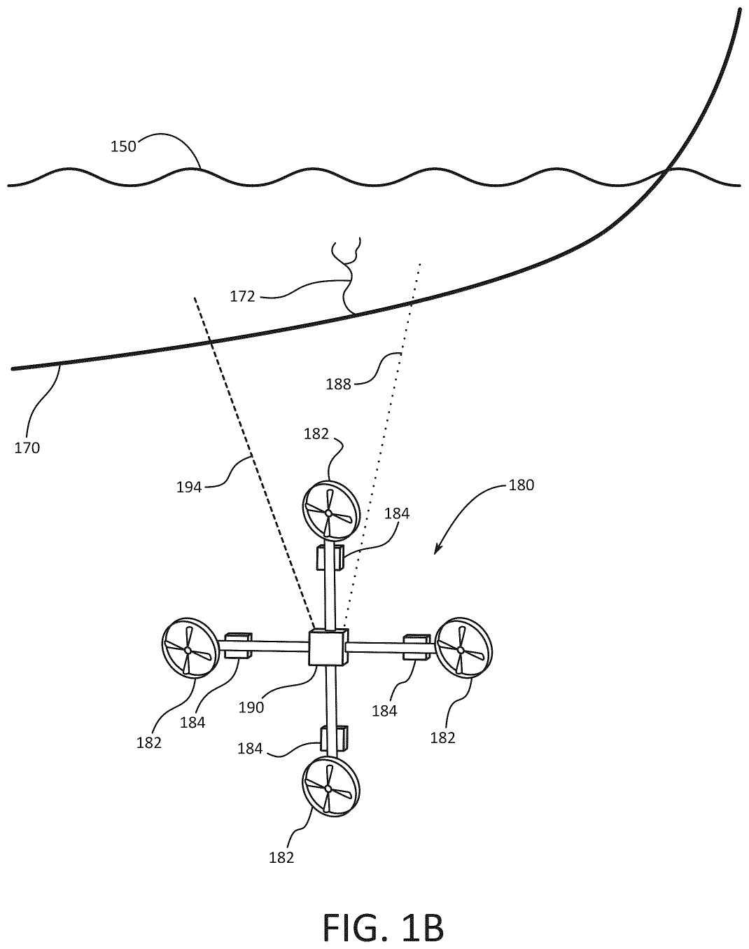

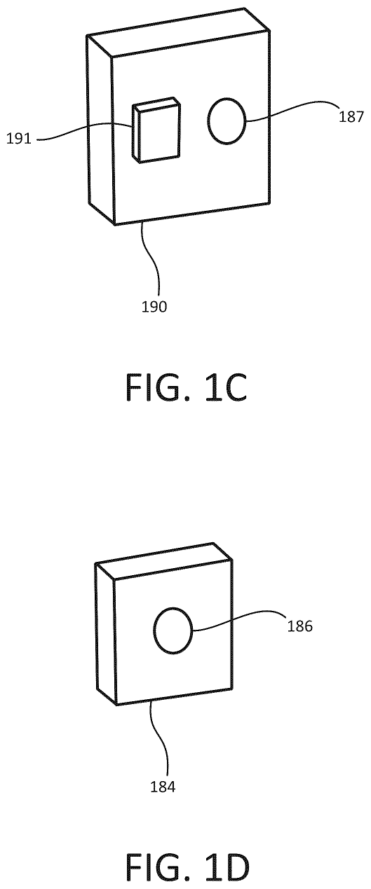

FIG. 1A describes a process of 3-D perception using multiple scanning modalities according to one embodiment. Process 100 may use a scanning system 180 as shown in FIG. 1B, which shows an example of a scanning system being used for underwater inspection. System 180 may use more than one scanning subsystem. In an example, a scene is shown that includes a ship 170 to be inspected. The scene shows a single object near the surface, but the system might be inspecting multiple objects at once, and might be inspecting near the surface, at the seafloor, or at other locations. Below the water surface 150, a system 180 can move around the ship 170 to inspect it for flaws or other details. The system 180 is configured with four propeller portions 182, though propulsion may be accomplished through other means (such as water jets or other types of propellers) or configurations with varying numbers of propulsion devices. A central portion 186, also shown in FIG. 1C, may include a sonar subsystem 191. The sonar subsystem 191 may be small and monolithic as to be present in the center of the system 180 as depicted, but in some embodiments, the sonar may be more distributed, with other receivers or emitters placed in various positions on the system 180. Sonar 191 scans a beam 194 across a scene, and in this example is measuring the ship 170. A light scanning subsystem may also be implemented on the scanning system 180. In one configuration, a scanner 187 can scan a beam 188 across the scene sequentially or simultaneously to the sonar. In most cases, beam 188 can be focused more tightly than the sonar beam 194. Thus, it is expected that sonar might be able to describe the general shape of objects but would be unable to resolve small details or features, whereas scanning triangulation might be able to see these features, such as small cracks 172 on the exterior surface of the ship 170. For purposes of describing the process 100, a single beam 188 can be used, but in specific embodiments, the system may comprise one or more scanners placed in different locations, where each scanner may emit one or more beams. In an embodiment, the light scanning subsystem comprises both ToF as well as triangulation using a scanning laser associated with two or more cameras and/or sensors for measuring the scene based at least in part on their detection of reflections for the scanned laser.

In this example, the system includes four receivers 184 mounted with significant positional disparity near the ends of the arms of the system 180. The receivers, shown in more detail in FIG. 1D, may include an event-type camera 186. Other compositions of the scanning systems are possible and exact positioning configuration is flexible. Though this example shows a beam scanner in the center with cameras distributed on farther arms, in some variants, a scanner may be placed at the arm with a camera instead at the center. Cameras may be placed as shown in a substantially planar arrangement around the central beam scanner, but they may be offset so that the scanning system is non-planar for additional disparity. In system 180, the lower-frequency sonar subsystem generally has much better range, but poorer overall resolution than other subsystem. In general, the cameras 186 are event-type cameras that have a pixel array, where each pixel can be triggered individually. In some embodiments, the time resolution of each camera pixel is high enough to enable ToF measurements for pixels triggered, with 1-10 ns resolution or faster, but in other embodiments, the time resolution of the pixels may significantly slower, yet the triggering time of the pixels may be configured to have fast resolution (i.e. one might select which nanosecond timestamp to enable the pixel or camera overall, whereupon pixels could be triggered). Event-type cameras may comprise an array of avalanche photodiodes (APDs), photo-multiplier tubes (PMTs), or other event capturing methods that report the timestamp of a pixel triggered. Pixels can often be triggered asynchronously, i.e., each pixel is independent of others in the array. The laser scanner 187 can be operated in a pulsed manner, where short pulses of light (possibly as short as 1 nanosecond or faster) scanned over the scene.

In step 110 of the process 100, the various subsystems are calibrated with respect to each other. The ToF and triangulation components can be measured with close objects to precisely calibrate their positions. All three subsystems can also be directly measured to find approximate positioning; once the approximate position is known, measurement of 3-D objects can further refine the exact position of each camera including rotation and translation. In addition, the timebases of the subsystems can be synchronized with respect to each other. Internally, scanning triangulation systems should be calibrated; typically, these work by measuring events (e.g., using event cameras, avalanche photodiode arrays, PMTs and the like) that are correlated in time with each other, and then used to measure positions of scanned surfaces in 3-D space. This also includes detailed measurements of the position of the scanning laser 187 with respect to each camera. The scanning laser 187 may include feedback systems that measure the output position of the scanning beam 188. Time base synchronization should be determined with respect to the sonar subsystem but is typically less important since the sonar subsystem often works much slower than the other subsystems.

In step 112, the sonar can be used to scan the scene to determine the rough position and shape of objects in the scene. Both near-and far-field objects can be scanned using the sonar. In this example, near-field is defined with respect to the triangulation subsystem. Though the sonar data can be used directly in mapping out the scene, particularly in the far-field where triangulation data may not be acquirable, but its primary use can be in filtering incoming data through the scanning triangulation subsystem to enable capture even under challenging conditions. Rough positions of objects in the scene as well as their range can be determined in this step. The scene is scanned using lasers in step 114; sonar data may not be initially available when this step is started since sonar scan may take longer than the laser scan, but useful information can still be determined here. Water clarity may be measured using other means but could be inferred and continually monitored over time by examining the quality of returning laser reflections from nearby objects. In clear conditions, reflections from an object in the near-field should give strong event reflections back at each event camera that can image that portion of the scene with low noise. As the beam scans over the object, events can be built up into connected trajectories that see the 3-D path of the beam as it traces over an object such as the ship 170. When there is little interference, events may appear close together in both time and space on each camera, and assignment of event points can be unambiguous. However, when there is even a moderate amount of turbidity or absorbing matter in the water, far less light may return to the event cameras, leading to gaps in capture along trajectories. Furthermore, there may also be more scattered light impinging on each camera, which can trigger many spurious events. These two metrics can be used as a continuous measure of water clarity. When the water is clear, 3-D perception might be accomplished using scanning triangulation alone, but turbid or otherwise obstructed water conditions are not expected to be uncommon. Environmental conditions may change quickly from clear to turbid as the object scanning continues.

In step 116, data from sonar can be used to filter triangulation data. Because the subsystems were calibrated earlier, when the surface position of an object is measured using sonar, the effective position of the object can be calculated relative to the triangulation subsystem as well, in particular to each camera in the subsystem. Range can be determined using sonar, and using this range, approximate anticipated ToF at the camera pixel array can also be calculated, i.e., the predicted arrival time of a pulse of light emitted by the laser. This position can be known with a substantially measured amount of uncertainty based on object range, size, as well as environmental conditions. Thus, the object position can be reported by sonar with a certain error range in angular space (i.e. X, Y coordinates), and also its Z depth can be reported as range=Z±ΔZ where ΔZ is the expected error in distance to the object surface. When the error range is uncertain, a higher error can be assumed to start.

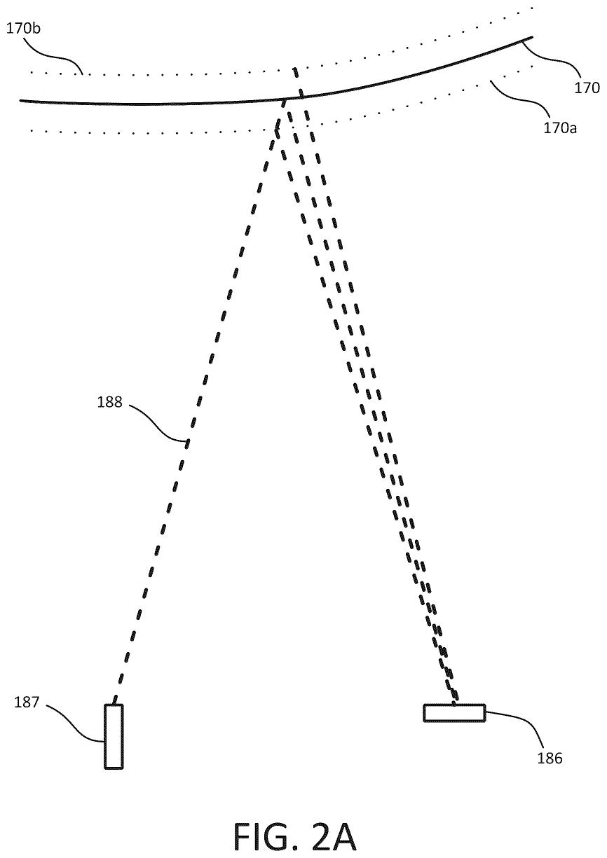

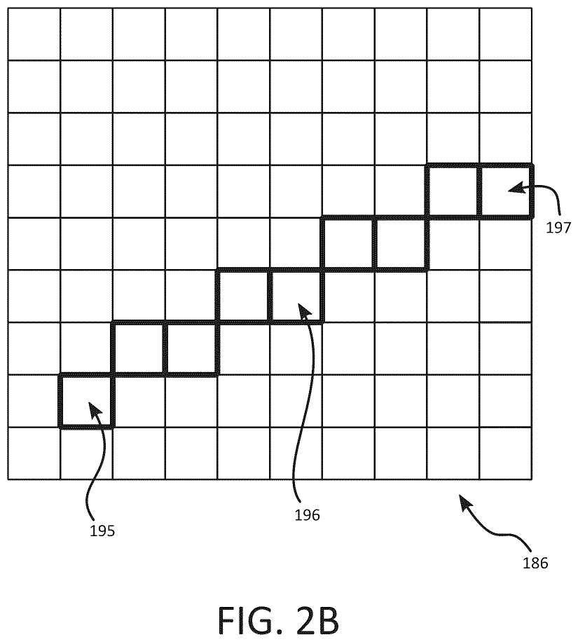

In step 116, sonar range and position data can be used to filter pixels in the receiver. The reflected object surface light should reflect in a calculated time from the emitted pulse, perhaps within nanoseconds, depending on the speed of light in the medium. Pixels in a subsection where signal is anticipated based on sonar information may be configured to trigger after the minimum possible arrival time of a reflected pulse, which corresponds to the shortest range on the object surface given the estimated ΔZ error. An example of this is seen in FIG. 2A, which shows ship 170 being scanned from a laser scanner 187. The beam 188 intersects the surface of the ship 170 at a particular point. In our example, sonar has reported that the distance from the system 180 to the ship is 5.0 m. However, there may be an error in this measurement, possibly placing the actual position of the point intersected by the beam 188 from 4.75-5.25 m away. This possible range is illustrated by curves 170a and 170b. Though there may normally be a plurality of event cameras viewing the scene, the figure shows one camera 186. The imaged reflection from the beam on the camera thus might appear over a range of points depending on the actual depth of the ship surface, illustrated by three beams showing the range of potential positions of where the beam intersection could be imaged on the event camera sensor. The three beams are showing chief rays of the optical system rather than all light reflected from the surface. FIG. 2B is a close-up view of a portion of the image sensor of camera 186, where the line of pixels outlined corresponds to possible imaged spots.

For example, pixel 195 may correspond to the left reflection line in FIG. 2A, and pixel 196 may correspond to the right reflection line. Within that range are other possible pixels are outlined in bold. The range can be narrowed down to a single line of pixels if there is relatively low uncertainty about the position of the beam angle at that moment in time. In other words, if the beam position coming out of the scanner is well-characterized at a particular time, then the potential imaged positions on the event camera can be calculated based on this angle by projecting this angle on the object surface to the event camera. If there is some uncertainty in the beam positioning, the range of potential pixels at the event camera could be widened at this step. Calculated pixels to trigger may also vary with position and rotation of each camera with respect to the beam scanning direction and each other. The size of the beam at the object may affect this as well, as the beam size may be imaged as covering several pixels.

In step 118, the ToF of the potential paths can be used to filter the data capture at the event sensor. In our example, if the actual range to the ship surface was 4.75 m, this might be imaged at pixel 195, whereas if the range was 5.25 m, pixel 197 would be illuminated. In the presence of no interfering noise, an event could simply be captured from the laser pulse. The true depth could be ascertained from where the pixel landed and refined much more precisely by comparing it with data from other event cameras in the system. However, a pixel firing in turbid water may be much more difficult to pick out. For instance, there may be much light scattering that would also lead to event pixels firing at similar timestamps to the pulse corresponding to the real reflection off the surface of the object. In addition, attenuation of the beam may make the signal reflection much lower energy; under those circumstances, sensitivity of the camera can be adjusted to detect fewer photons to trigger an event, but this may lead to even more noisy pixels triggering. However not just changes in position would be expected by uncertainty in range, but also changes in total ToF of the reflection. In the uncertainty range, ToF of the beam could range from 43-47 nanoseconds. Filtering by time can be done in a number of ways. In the most simple, based on the reported sonar depth, the possible range of times of light return can be calculated. When a pulse of light is emitted, either the entire event camera (or a subrange) could be configured to open at just 43 nanoseconds. In this manner, any scattering of light before light could possibly return from an object would be eliminated as it would not trigger an event. Because most scattering happens as the light travels from the laser scanner toward the object, the ToF of the scattered light would necessarily be faster than light hitting a measured object since the distance is shorter. However, in some embodiments, when the potential return positions of pixels that could be triggered is better known (as shown in FIG. 2B), then just those pixels could be triggered. These pixels might be triggered at different times to further filter out other noise. For example, since pixel 195 might be imaged if the range to the object is 4.75 m at the beam intersection, then pixel 195 could be configured to trigger after 43 nanoseconds. Similarly, pixel 197 might be configured to trigger 47 nanoseconds after the laser pulse. Bold pixels along the line of potential imaging locations could have intermediate trigger times (pixel 196 might trigger at 45 ns). In some embodiments, the pixel triggering times might be configured to be active within a certain time window. For instance, pixel 195 may be available to be triggered from 43.0-43.5 nanoseconds. This 500 picosecond window is arbitrary, and could be adjusted to optimize signal pickup. Overlap in time windows between adjacent pixels may be allowed as well. In cases where a higher resolution camera is used, the time window might be shortened; for example, if an event camera with a 1200 pixel linear resolution and a field of view (FOV) of 24° was used, then the range of pixels similar to FIG. 2B may span 50 or more pixels. In this case, a time window of 50 picoseconds/pixel or less may be achievable. There may be optimization of the time window value as there are trade-offs to consider. A longer time window would allow fewer missed captures of object data during the scan, but a shorter time window could allow data capture even in the presence of other light interference from scattering, ambient light, or other sources.

In some embodiments, filtering may be done after the measurement through calculation and elimination of data captured before the targeted calculated time of the object surface rough position. This is possible when there is not too much backscatter of light creating many extraneous events and the event sensor hardware can capture event time data precisely, but in many embodiments, filtering may be applied at the hardware level at step 116 as described before, where the pixels themselves are set to be triggered after a set time. In addition, step 116 can be used to verify object data; in some cases, spurious reflections of other objects, thermal gradients, and the like may cause signal on the sonar scan for an object that is not in its measured position or doesn't exist at all. By checking against the data from triangulation, the nature of data artifacts such as these can be determined. In event cameras where the ToF arrival time at a pixel is sufficiently precise to estimate the depth, this data can act as additional corroborating data about object position and range.

In general, other steps are occurring independently at each event camera. In step 120, data from each camera are combined to calculate 3-D information about the scene using the triangulation data. Because knowledge of the position has now been improved compared to earlier sonar data, further refinement of calculated expected positions can be made before further scanning the objects. However, this method could be used, even event-type cameras that have time resolution several orders of magnitude slower than nanosecond level ToF sensors may still be able to reject additional noisy light from scattering or other noise sources, as they could be triggered to respond at the appropriate expected return time. Triggering might be done at the electronic level in this case, but in some embodiments fast optical shutters might be used to filter light that might enter at undesirable times.

Scanning triangulation systems often capture events scanned from an object surface and can then tie them together over the portion of the scan on that object surface into beam trajectories. The trajectories can be captured at each event-type camera, and when compared to one another, may resolve very high-resolution details, particularly in the near-field range. Piecing trajectories of events together is another way the scanning system can improve surface data, but this may also assist when conditions are noisier. Though a scanning triangulation system might be able to capture the same high-resolution data by itself under more ideal conditions, as soon as some turbidity in water is added, obtaining clear smooth trajectories may be more difficult, since there may be fewer events captured per scan because of light attenuation, but also increased interference from scattered light. Using process 100 may eliminate many of the sources of interference. Events are normally expected to be connected (i.e., events can be captured both temporally as well as spatially near on each camera), and so if the approximate location and shape of a surface is known, then events with close proximity can be captured as part of an event trajectory; this can act as an additional filter on whether to accept or reject event data. Using time data from the other subsystem to restrict event capture enables the triangulation subsystem to scan at very high resolution even in the presence of turbidity (or other interference) that would otherwise prevent reliable data capture.

Finally, in step 122, the process can be iterated back to step 112. Note that not each portion need always wait for data from other steps to proceed. Sonar scanning of an environment may take substantially longer than a triangulation scan, so latter two can proceed even while waiting for data from sonar to arrive. Note that this is a simple example showing one scanning beam. In some embodiments of a scanning system, multiple laser beams may be scanning the scene simultaneously, and thus several ranges (possibly with different trigger times) may be setup for each camera in the system. For instance, in the example of FIG. 2B, where just one beam was captured on any of the cameras, then the entire camera could be triggered as mentioned. When multiple beams could be captured by each camera simultaneously, then possible calculated ranges for each beam should be done. In some cases, beams are not correlated in position with each other even though they may be sent out at substantially the same time, so different beams might be hitting different objects in the scene. Subranges of each camera could be configured to trigger at times corresponding to those distance ranges that may be different. In specific embodiments, the position of the scanning beam relative to the cameras may be tracked more closely as it scans using a direct feedback measurement system, or otherwise calibrating the scanning pattern over time. In this way, using the rough position of the object surface from either sonar or Lidar, the true expected geometric location of the beam can be characterized within a small error range ahead of time. This may localize further the expected angular range where signal may appear and could improve filtering of noisy events. In specific embodiments, scanning beams for the scanning triangulation subsystem could be modulated to improve filtering further. In some cases, the temporal leading edge of the beam can be detected which may further improve the accuracy of the beam tracking (and thus improve detail and accuracy of the surface depth profile).

Other variations are possible when using multiple scanning beams. For instance, the output times of beam pulses could be staggered so that there is little chance of overlap in return signals. Thus, beams returning at different times could be easily distinguished from one another. Note that overlap of beam emission times might be possible, but other methods could also be used to disambiguate beams. Even beams that return at similar times may have different characteristics, especially when measured as trajectory paths of multiple events. Trajectories may appear to cross geometrically at different times, they may have different epipolar matches on each camera, or both. These can be used to remove overlap and distinctly assign beams for identification. Using these secondary methods to assign beams has other advantages as well; when a beam can be positively identified, then the timing can be further refined knowing the exact time each beam was emitted initially. This could be useful even when using a camera that has much slower time resolution (perhaps even in the microsecond time scale) but still allow nanosecond precision to when the beam was emitted and detected.

Also, other adjustments may be made to improve continuing scans. For instance, once some knowledge of triangulation data of a surface arrives, this immediately can help pinpoint the true range of the object. In some cases, this may be used to improve a scan trajectory as it is being scanned. If the range of the object at a spot was determined, then the range at near spots should be similar. In our previous example, sonar range at a given point was estimated at 4.75 m-5.25 m. If several points along the scan were measured at approximately 5.04 m distance, this could be used to narrow the window of times and positions to look for future events along the same scan. This window cannot be narrowed down indefinitely, as the range is expected to change along the surface profile; not just the distance changes to the cameras along the scan path, but also features on the surface need to be detectable. Nevertheless, this could reduce noise further. In addition, the scanning triangulation system continues to scan many trajectories over the objects in the scene. When either the scanning system 180 or the objects in the scene are not moving substantially between scan times (which may be as short as a few hundred nanoseconds), then data from one scan trajectory can be used ahead of time to aid in filtering data for future scan trajectories. This becomes more useful as a complete 3-D model is built up over the course of many scans.

In some embodiments, at step 122 the beam tracking calibration can be updated. Though there may be some feedback on beam position at the laser scanner, actual 3-D measurements of the position of the beam and where it intersects the objects can refine this position over time. Thus, the feedback from the beam position measurement can be updated to its actual position if it is slightly off. This may narrow the range of potential pixels to be triggered.

In some embodiments, other parameters of the system could be adjusted while at step 122. For instance, bias or gain might be adjusted when using APDs (or other event-type pixels) in the event camera detector based on changing environmental conditions. As mentioned previously, when the water is very clear, little absorption or scattering occurs, and a better quality signal can be detected at the camera. Millions of photons from each spot may be detectable under those conditions, but when there is significant attenuation, the event sensors may have to be run in more sensitive modes. When there is much light available, sensitivity can be reduced to require many photons to trigger, but under high attenuation, the sensitivity can be increased to detect as few as ten photons (perhaps by running an APD in Geiger mode). How these parameters are set depends on conditions. When conditions are relatively stable, it may be sufficient to check them occasionally, but most often use parameters set at the initial calibration step. However, when conditions are rapidly changing, a more dynamic process may be needed. In water, attenuation is often composed of scattering as well as absorption. The relative ratio of absorption to scattering at the wavelength or wavelengths used in scanning can determine how the detectors are configured. Attenuation from either source typically shows an exponential drop-off in light transmitted with respect to length of water traversed. When absorption effects are dominant in attenuation, then beam power and/or sensor sensitivity can be increased to compensate. However, if scattering becomes a significant percentage of attenuation, it may be not sufficient to simply increase the power or sensitivity. Under high scattering conditions, light scattering from the emitted beam can return to the event sensor and trigger an event, though the pixels triggered may generally be offset from those that would reflect from objects to be measured. Scattering artifacts from scanning triangulation are expected to be fewer than those obtained by other 3-D measurements though. For example, Lidar measurements commonly measure light returned either along the axis of the emitted beam or at a near to this angle. Backscatter along these directions can be compounded as light returns to the sensor, and in many cases can be higher than actual signal reflecting from the object itself. In the scanning triangulation example shown here, scattered light appears at the sensor not just at a point or small portion of the sensor but projected along a larger line segment of the event sensor array. Because the scattered light is distributed, it can be less intense at any point, thus it should be possible to change the sensitivity of the pixels to trigger upon reflection from an object but ignore scattered light along the beam. Scattering events that still occur can still be filtered out using geometrical and timing constraints as mentioned earlier.

To illustrate the preceding point, let's assume a system where the beam emitter has a disparity of 1.0 m from one of the event cameras. When measuring an object 5.0 m away from the emitter, let's also assume very poor visibility conditions, where there is significant turbidity in the water such that transmission is 50%/m. Furthermore, in worst case conditions for noise, let's also assume that scattering dominates attenuation, being composed of 98% scattering and 2% absorption. For a camera with 1200 linear pixel width and total FOV of 40°, then the sensor has around 30 pixels/degree angular resolution. Although an APD (or a PMT) could be tuned to pick up even single photons, this may subject the camera to a large amount of noise even if it has a strong bandpass filter allowing light through of the wavelength of the laser scanner. To be prudent, we might set the camera to trigger an event at 10 photons. At this level of scattering and attenuation, to measure ten photons of signal from an object, the laser may send out ˜4e9 photons. Though a large number of these photons scatter, much of the scattering happens within the first two meters, or at least is best detected within this range due to 1/R2 drop-off. In this illustration, the extend of the FOV of the camera does pickup some light scattering, but are seen at the event at a level of 40-50 photons/pixel, not far from the level captured for the signal. By the time the beam approaches the object, scattered photons/pixel drop to 3-4 photons/pixel, below the triggering threshold. Thus, it might be reasonable to be able to separate signal from noise from separation on the image sensor alone. However, this is not the case in practice, because by triggering the event array to filter both in spatial range as well as time, almost all the scattering is not captured at all. Because of the strong filtering, even if the scattered light was orders of magnitude higher than the signal level, it would still be possible to filter it out using the methods described herein.

In some embodiments, the triggering time of the emitted laser pulse for beam scanning may be adjusted instead or in addition to adjusting the triggering time of the beam receiver. In step 116 of the process as described previously, each scanning beam may send out pulses at regular intervals, and calculations are done to determine ranges of pixels and times where they might appear at the event camera. Instead, the event camera or cameras might be triggered by a regular clock. The speed is somewhat arbitrary but should be chosen to allow one or more signals to return in between cycles. In an example, a 1 MHz clock might be used to arm an event camera. Geometry may be similar as to that already discussed in FIGS. 2A and 2B, where a certain range of pixels and times might be expected for a return signal. If the shortest time expected return was 43 nanoseconds, then a laser pulse could be sent exactly 43 nanoseconds before the 1 MHz clock tick. In some embodiments, the entire image sensor array (or an appropriate subrange of the array) could be opened at the 1 MHz clock tick, similarly eliminating early noisy events due to scattered light. In addition, there may be offset circuitry that allows other portions along a set of pixels to ripple forward for triggering with a narrow time window as before. For example, with a 43-47 nanosecond range of return times, in FIG. 2B pixel 195 could be triggered to be open for events at the 1 MHz clock tick, pixel 196 at 2.0 nanoseconds thereafter, and pixel 197 at 4.0 nanoseconds after the clock tick. The relative timing would be the same as before among the various pixels, but the laser pulse emission time would change over the course of a scan. Otherwise, the data and process 100 would be followed similarly as described previously.

In some embodiments, process 100 could be adjusted to work with radar instead of sonar when doing 3-D perception of scenes through air instead of in water. Though these situations may seem quite different, there are a number of close analogies that allow the process 100 to work with minimal changes. In air, rather than turbidity, weather conditions can affect how well laser signals can impinge upon targets to be measured. For example, dense fog can have a large scattering effect on light passing through it but has much less effect in hindering passage of microwave-scale light used for most radar. Radar is commonly used not just to measure weather, but to scan through it. In many applications, radar can be used to supplement other methods used in air, and can be a common addition to autonomous vehicles, robot delivery vehicles, flying drone inspection systems, and others. Like sonar underwater compared to scanning triangulation, radar has a lower frequency than visible or near visible light and can have a much longer range in low-visibility conditions than visible light, yet it similarly to sonar reports a lower resolution signal as compared to visible light, with a higher uncertainty depth range. Other environmental conditions may apply as well. The amended system could be used during precipitation, though the type and degree can affect the results. Rain and snow can have varying effects on light hitting or passing through but may not completely block all the signal from hitting targets all the time. Reflection events may be picked up more strongly in these cases on event cameras as compared to light scattering in water yet could still be rejected if they fall outside expected calculated times and locations on the image sensors.

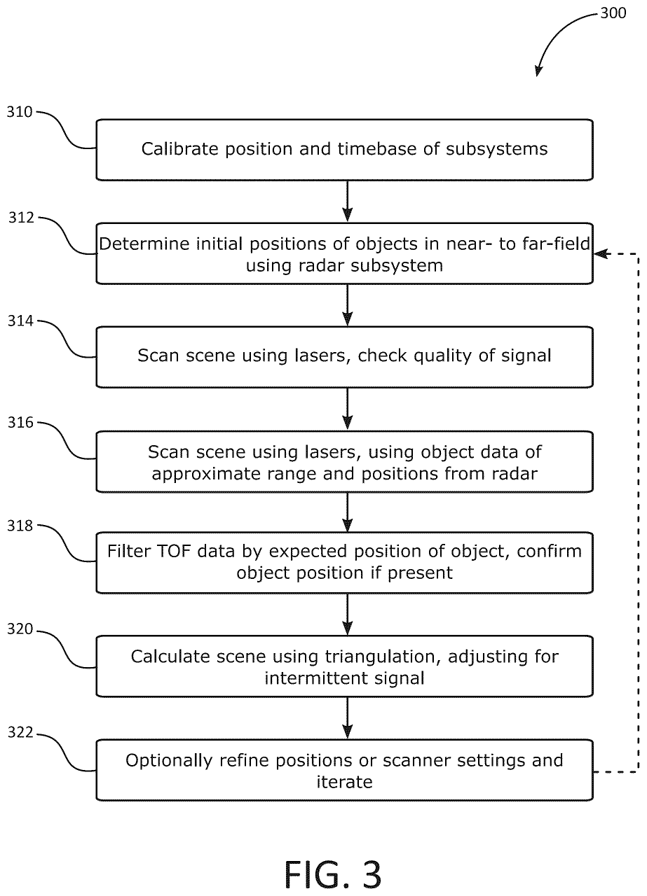

FIG. 3 shows an amended process 300 for measuring scenes in the air using radar and scanning triangulation. Generally, steps are followed substantially similarly to those in process 100, so just differences are discussed. In, step 312, the scene is measured using radar. The exact type of radar is not specified here, but quality of the signal can depend on the type of radar used. Generally, this may be similar to underwater, with one or more objects measured with approximate angular positions and an approximate depth range from the scanning system used, which can be passed on to later steps. In step 314, the system can determine by the quality of initial laser scans how much interference to expect from weather conditions; in clearer conditions, the radar data may be less needed, but the system can continuously monitor this to determine when additional steps should be taken to filter out noisy data. Step 316 is almost the same as step 116 but substituting radar range data for sonar. Step 320 is calculated the same as step 120. In certain conditions perception algorithms to capture scan trajectories can be adjusted. In snow, for instance, at some times the laser scanner may be able to reach the object without hindrance as it passes by all snowflakes from to the object and back to the camera. At other times the light may be completely blocked by one or more snowflakes. The perception pipeline may need to be changed when interpreting data from the system, particularly when fitting smooth trajectories corresponding to the laser scan beam path. Light received may be more intermittent than before, where connected events on a trajectory may not appear as close together in space and time. However, if they appear within time window ranges and positions as calculated, they should still be considered as part of signal in the scanned trajectory. In general, these trajectories may be improved with increasing number of event-type cameras in the system. For example, when there are many cameras viewing the scene, possibly with multiple beams scanning the scene, there is much more chance of one or more beams hitting objects rather than snow. When the beam does intersect with an object surface, then having multiple cameras viewing the object may allow data capture in cases where more than one camera can view that spot without occlusion at that moment in the scan. When data is combined from the multiple cameras, it may be used to fill in gaps where data was just available from some of the cameras rather than all of them at each point in time. Additionally, one or more thermopile laser sensors may be employed to detect a power of the one or more scanned beams that are reflected by one or more objects.

Although the invention has been discussed with respect to various embodiments, it should be recognized that the invention comprises the novel and non-obvious claims supported by this disclosure.

1. (canceled)

2. A system for determining locations of structures in a three-dimensional (3-D) environment, including:
a scanning device that emits one or more wireless signal beams that are scanned toward one or more structures in the 3-D environment;
one or more of a first type of sensor and a second type of sensor to detect a plurality of reflections of the one or more wireless signal beams from the one or more structures; and
circuitry that is operative to determine a position and a range of the one or more structures based on the plurality of detected reflections, wherein a combined result of the plurality of reflections detected by the one or more of the first type of sensor and the second type of sensor is used to decrease latency and increase precision in the determination of the position and the range for each structure located in the 3-D environment.

3. The system of claim 2, wherein the first type of sensor further comprises:
an event camera with a plurality of pixels that are operative to individually and asynchronously detect the one or more reflections of the one or more wireless signal beams.

4. The system of claim 2, wherein the second type of sensor further comprises:
an image camera with a plurality of pixels that are operative to synchronously detect the one or more reflections of the one wireless signal beams.

5. The system of claim 2, wherein the determination by the circuitry further comprises:
filtering one or more portions of the plurality of reflections arriving outside an expected temporal window that are detected by the first sensor based on the one or more portions of the plurality of reflections that are detected by the second sensor to reduce noise caused by scattered light.

6. The system of claim 2, wherein the determination by the circuitry further comprises:
monitoring one or more environmental conditions to dynamically adjust one or more parameters for one or more of the first type of sensor or the second type of sensor.

7. The system of claim 2, further comprising:
one or more of a third type of sensor that is operative to detect a plurality of sonar wireless signal reflections from the one or more structures that are located underwater in the 3-D environment.

8. The system of claim 2, further comprising:
one or more of a fourth type of sensor that is operative to detect a plurality of radar wireless signal reflections from the one or more structures that are located in an atmosphere of the 3-D environment.

9. The system of claim 2, wherein the determination by the circuitry further comprises:
determining one or more metrics based on one or more of a strength, a power, or a noise ratio for one or more portions of the plurality of reflections detected by the one or more of the first type of sensor or the second type of sensor.

10. The system of claim 2, wherein the determination by the circuitry further comprises:
disambiguating one or more portions of the plurality of reflections for two or more scanned wireless signal beams based on one or more of a staggered emission time, a trajectory path or an epipolar match.

11. The system of claim 2, wherein the determination by the circuitry further comprises:
calibrating the one or more of the first type of sensor and the second type of sensor based on a relative position to each other and a respective time to detect a reflection.

12. A method for determining locations of structures in a three-dimensional (3-D) environment, including:
emitting one or more wireless signal beams, with a scanner device, that are scanned toward one or more structures in the 3-D environment;
using one or more of a first type of sensor and a second type of sensor to detect a plurality of reflections of the one or more wireless signal beams from the one or more structures; and
determining a position and a range of the one or more structures based on the plurality of detected reflections, wherein a combined result of the plurality of reflections detected by the one or more of the first type of sensor and the second type of sensor is used to decrease latency and increase precision in the determination of the position and the range for each structure located in the 3-D environment.

13. The method of claim 12, wherein the first type of sensor further comprises:
an event camera with a plurality of pixels that are operative to individually and asynchronously detect the one or more reflections of the one or more wireless signal beams.

14. The method of claim 12, wherein the second type of sensor further comprises:
an image camera with a plurality of pixels that are operative to synchronously detect the one or more reflections of the one wireless signal beams.

15. The method of claim 12, wherein the determination further comprises:
filtering one or more portions of the plurality of reflections arriving outside an expected temporal window that are detected by the first sensor based on the one or more portions of the plurality of reflections that are detected by the second sensor to reduce noise caused by scattered light.

16. The method of claim 12, wherein the determination further comprises:
monitoring one or more environmental conditions to dynamically adjust one or more parameters for one or more of the first type of sensor or the second type of sensor.

17. The method of claim 12, further comprising:
using one or more of a third type of sensor to detect a plurality of sonar wireless signal reflections from the one or more structures that are located underwater in the 3-D environment.

18. The method of claim 12, further comprising:
using one or more of a fourth type of sensor to detect a plurality of radar wireless signal reflections from the one or more structures that are located in an atmosphere of the 3-D environment.

19. The method of claim 12, wherein the determination further comprises:
determining one or more metrics based on one or more of a strength, a power, or a noise ratio for one or more portions of the plurality of reflections detected by the one or more of the first type of sensor or the second type of sensor.

20. The method of claim 12, wherein the determination further comprises:
disambiguating one or more portions of the plurality of reflections for two or more scanned wireless signal beams based on one or more of a staggered emission time, a trajectory path or an epipolar match.

21. The method of claim 12, wherein the determination further comprises:
calibrating the one or more of the first type of sensor and the second type of sensor based on a relative position to each other and a respective time to detect a reflection.
